(19) United States
(12) Patent Application Publication
(10) Pub. No.: US 2023/0225421 A1
(43) Pub. Date: Jul. 20, 2023

(54) AEROSOL-GENERATING COMPONENTS AND METHODS OF PREPARING THE SAME

(71) Applicant: Nicoventures Trading Limited, London (GB)

(72) Inventors: Shasa HARRIS, London (GB); Anna AZZOPARDI, London (GB)

(21) Appl. No.: 17/996,380

(22) PCT Filed: Apr. 23, 2021
(86) PCT No.: PCT/GB2021/050987

§ 371 Date: Oct. 17, 2022

(30) Foreign Application Priority Data
Apr. 23, 2020 (GB) 2005970.5

(51) Int. Cl. A24F 40/70; A24F 40/46; B33Y 10/00; B33Y 80/00

(52) U.S. Cl. CPC A24F 40/70; A24F 40/46; B33Y 10/00; B33Y 80/00

(57) ABSTRACT

An aerosol-generating component including at least one active that is not nicotine, wherein the aerosol-generating component is formed by an additive manufacturing process from a feedstock material including the at least one active. There is also provided a process for preparing an aerosol-generating component including at least one active that is not nicotine, wherein the at least one active is included in a feedstock material that is used to form the aerosol-generating component by an additive manufacturing process. Also provided is a delivery system including an aerosol-generating component as described herein.

### PRIORITY CLAIM

The present application is a National Phase entry of PCT Application No. PCT/GB2021/050987, filed Apr. 23, 2021, which claims priority from GB Application No. 2005970.5, filed Apr. 23, 2020, each of which is hereby fully incorporated herein by reference.

### TECHNICAL FIELD

The invention relates to aerosol-generating components for inclusion in an aerosol provision system, such as an apparatus for heating aerosol-generating material to volatilize at least one component of the material. The invention also relates to methods for preparing such components.

### BACKGROUND

Aerosol-generating material may include a variety of different active substances and/or flavors and a user selects aerosol-generating material to provide the desired user experience.

### SUMMARY

In accordance with some embodiments described herein, there is provided a process for preparing an aerosol-generating component comprising at least one active that is not nicotine, wherein the at least one active is included in a feedstock material that is used to form the aerosol-generating component by an additive manufacturing process.

In some embodiments, the active that is not nicotine is selected from the group consisting of the actives listed in Table 1 below.

In some embodiments, the aerosol-generating component comprises at least one further active. In some embodiments, the at least one further active is included in at least one further feedstock material used to form the aerosol-generating component.

In some embodiments, the aerosol-generating component further comprises nicotine. In some embodiments, the feedstock material comprises tobacco material.

In some embodiments, the aerosol-generating component is a unitary aerosol-generating component comprising at least two portions comprising different actives. In some embodiments, the at least two portions are formed by the additive manufacturing process using different feedstock materials.

In some embodiments, the additive manufacturing process forms a three-dimensional object from the feedstock materials using a computer-aided design (CAD) model.

In some embodiments, the additive manufacturing process is a 3D printing process depositing layer upon layer of feedstock material.

In accordance with some further embodiments described herein, there is provided an aerosol-generating component comprising at least one active that is not nicotine, wherein the aerosol-generating component is formed by an additive manufacturing process from a feedstock material comprising the at least one active.

In some embodiments, the aerosol-generating component comprises at least one further active. In some embodiments, the at least one further active is included in at least one further feedstock material used to form the aerosol-generating component.

In some embodiments, the active that is not nicotine is selected from the group consisting of the actives listed in Table 1 below.

In some embodiments, the aerosol-generating component further comprises nicotine. In some embodiments, the aerosol-generating component comprises tobacco material.

In some embodiments, the aerosol-generating component is a unitary aerosol-generating component comprising at least two portions comprising different actives. In some embodiments, the at least two portions comprise different aerosol-generating materials.

In some embodiments, a first portion comprises the at least one active that is not nicotine and a second portion comprises a second active that is different to the first active.

In some embodiments, the first and second portions have a different pH.

In accordance with some further embodiments described herein, there is provided a delivery system comprising an aerosol-generating component as disclosed herein.

In some embodiments, the delivery system is a non-combustible aerosol provision system. In some embodiments, comprising a heating means to heat the aerosol-generating component.

In accordance with some further embodiments described herein, there is provided a consumable comprising an aerosol-generating component as disclosed herein.

### BRIEF DESCRIPTION OF THE DRAWINGS

Embodiments of the invention will now be described, by way of example only, with reference to accompanying drawings, in which:

FIGS. 1, 2 and 3 are schematic illustrations of aerosol-generating components in accordance with various different embodiments described herein.

### DETAILED DESCRIPTION OF THE DRAWINGS

In some aspects, the invention relates to an aerosol-generating component comprising at least one active that is not nicotine, wherein the at least one active is included in a feedstock material that is used to form the aerosol-generating component by an additive manufacturing process.

An additive manufacturing process is a particularly convenient process for manufacturing such aerosol-generating components. Such a process may be used to form an aerosol-generating component from one or more feedstock materials, depositing the feedstock material(s) layer upon layer. In embodiments where the aerosol-generating component comprises more than one aerosol-generating material, the material may be deposited layer upon layer so that portions are formed from different feedstock materials and so that these different portions are attached to one another to form a unitary component.

An aerosol-generating material is a material that is capable of generating aerosol, for example when heated, irradiated or energized in any other way.

As used herein, the aerosol-generating components are components that are ready for use in a delivery system, such as a non-combustible aerosol provision system. In some embodiments, this means that the aerosol-generating component is ready to be used in a delivery system without the need for any further adaptation or processing.

Aerosol-Generating Material

In some embodiments, the aerosol-generating materials may comprise one or more active substances and/or flavors, one or more aerosol-former materials, and optionally one or more other functional material.

According to the present disclosure, at least one active included in the aerosol-generating material is not nicotine. In some embodiments, at least one active is included in addition to the active that is not nicotine.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise constituents, derivatives, or combinations of known active substances. For example, the active substance may comprise one or more constituents, derivatives or extracts of tobacco, cannabis or another botanical.

In some embodiments, an additional active substance comprises nicotine.

In some embodiments, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco. In some embodiments, the active substance comprises or is derived from one or more botanicals or constituents, derivatives or extracts thereof and the botanical is not tobacco.

In some embodiments, the active substance comprises or derived from one or more botanicals or constituents, derivatives or extracts thereof and the botanical is selected from eucalyptus, star anise, cocoa and hemp.

The active substance may comprise one or more constituents, derivatives or extracts of cannabis, such as one or more cannabinoids or terpenes.

In some embodiments, the active substance comprises or derived from one or more botanicals or constituents, derivatives or extracts thereof and the botanical is selected from rooibos and fennel.

In some embodiments, an additional active substance is nicotine. This may be provided in the feedstock and aerosol-generating material in the form of particles of tobacco material, a tobacco extract, and/or a purified or synthetic form of nicotine.

In some embodiments, the aerosol-generating material comprises one or more active is selected from the group consisting of the actives listed in Table 1 below.

TABLE 1

| | | |
|---|---|---|
| 5-Hydroxytryptophan | Guarana | Rhizoma |
| (5-HTP)/oxitriptan/ | | gastrodiae |
| Griffonia simplicifolia | | |
| Acetylcholine | Hops | Rhodiola |
| Arachidonic acid | Jasmine | Rhodiola |
| (AA, Omega-6) | | rosea |
| Ashwagandha | Kaempferia | Rose |
| (Withania | parviflora | essential |
| somnifera) | (Thai ginseng) | oil |
| Bacopa monniera | Kava | Rosemary |
| Beta Alanine | L-carnitine | S-adenosylmethionine |
| | | (SAMe) |
| Beta-Hydroxy-Beta- | L-arginine | Sceletium |
| Methylbutyrate (HMB) | | tortuosum |
| Caffeine | Lavender Oil | Schisandra |
| Centella asiatica | L-choline | Selenium |
| Chai-hu | Lemon balm | Serotonin |
| Chamomile | Lemongrass | Skullcap |
| Cherry | Liquorice | Spearmint |
| blossom | | extract |
| Cinnamon | L-lysine | Spikenard |
| Citicoline | L-theanine | Taurine |
| Cotinine | L-tryptophan | Terpens |
| Creatine | Lutein | Theacrine |
| Curcumin | Magnesium | Theobromine |
| Docosahexaenoic acid | Magnesium | Tumaric |
| (DHA, Omega-3) | L-threonate | |
| Dopamine | Matcha | Turmeric |
| Dorstenia | Melatonin | Turnera |
| arifolia | | aphrodisiaca |
| Dorstenia | Myo-inositol | Tyrosine |
| Odorata | | |
| Essential oils | Nardostachys chinensis | Valerian |
| Fennel | Nitrate | Vitamin A |
| GABA | Oil-based extract | Vitamin B12 |
| | of Viola odorata | (Cobalamin) |
| Galphimia glauca | Oxygen | Vitamin B3 |
| Ginger | Phenylalanine | Vitamin B6 |
| Ginkgo biloba | Phosphatidylserine | Vitamin C |
| Ginseng | Quercetin | Yerba mate |
| Glutamic acid | Resveratrol | |

In some embodiments, the aerosol-generating material comprises one or more active that has been associated with particular physiological and/or psychological effect. For example, the active may be associated with improved alertness, improved focus, increased energy, increased stamina, increased calm or improved sleep.

Numerous actives have been demonstrated to have such effects. For example, taurine has been linked to improved performance in muscle strength and endurance, endurance exercise tests, jumping and sport-specific actions (see Souza, D. B., et al. Acute effects of caffeine-containing energy drinks on physical performance: a systematic review and meta-analysis. Eur J Nutr 56, 13-27 (2017)). L-theanine has been shown to have some relaxing effects under resting conditions and may be an even more effective relaxing agent in such circumstances than the standard benzodiazepine anxiolytic, alprazolam (see Kristy Lu, et al, The acute effects of L-theanine in comparison with alprazolam on anticipatory anxiety in humans. Human Psychopharmacol Clin Exp 2004; 19; 457-465). Caffeine and L-theanine have been shown to improve performance on cognitively demanding tasks, demonstrating improved alertness, accuracy speed and accuracy (see Gail N. Owen, et al The combined effects of L-theanine and caffeine on cognitive performance and mood, Nutritional Neuroscience, 11:4, 193-198 (2008) and T. Giesbrecht, et al (2010) The combination of L-theanine and caffeine improves cognitive performance and increases subjective alertness, Nutritional Neuroscience, 13:6, 283-290). It has also been demonstrated that GABA (γ-aminobutyric acid) and L-theanine are effective in improving sleep quality (see Suhyeon Kim, t al (2019) GABA and L-theanine mixture decreases sleep latency and improves NREM sleep, Pharmaceutical Biology, 57:1, 64-72).

In some embodiments, the feedstock and the aerosol-generating material comprise a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

In some embodiments, the feedstock and the aerosol-generating material comprise an aerosol-former material. The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the feedstock and aerosol-generating material comprise one or more functional materials. The one or more other functional materials may comprise one or more of pH regulators, coloring agents, preservatives, binders, fillers, stabilizers, and/or antioxidants.

Suitable binders include, for example, pectin, guar gum, fruit pectin, citrus pectin, tobacco pectin, hydroxyethyl guar gum, hydroxypropyl guar gum, hydroxyethyl locust bean gum, hydroxypropyl locust bean gum, alginate, starch, modified starch, derivatized starch, methyl cellulose, ethyl cellulose, ethylhydroxymethyl cellulose, carboxymethyl cellulose, tamarind gum, dextran, pullalon, konjac flour or xanthan gum.

In some embodiments the aerosol-generating component comprises two or more different aerosol-generating materials. In some embodiments, the different materials generate different aerosols.

In some embodiments, the different aerosol-generating materials are included as different portions of the aerosol-generating component. In some embodiments, a user inhaling the aerosols generated by the portions of the aerosol-generating component may not perceive any difference between the aerosols generated by different portions. For example, the differences in the aerosol-generating materials may be designed to provide the user with a consistent sensory experience. In other embodiments, the different portions of the aerosol-generating component generate different aerosols that the user can distinguish between. In such embodiments, the component provides the user with a changing experience as the different portions generate an aerosol.

In some embodiments, two or more of the portions of the aerosol-generating component comprise different actives.

In other embodiments, two or more of the portions of the aerosol-generating component comprise the same active but in different amounts or strengths.

In some embodiments, two or more of the portions of the aerosol-generating component comprise different flavors.

In other embodiments, two or more of the portions of the aerosol-generating component comprise the same flavors but in different amounts or strengths.

In some embodiments, two or more of the portions of the aerosol-generating component have a different pH.

In some embodiments, the aerosol-generating component comprises an aerosol-generating material having a basic pH. For example, the pH may be at least about 7.5. In some embodiments, the aerosol-generating material with a basic pH comprises one or more bases or a basic buffer system.

The purpose of adjusting the pH of the aerosol-generating material is to provide the constituents in a chemical form which means that they are readily released from the aerosol-generating component, and/or they are readily transferred to the aerosol generated by the delivery system used to generate the aerosol from the aerosol-generating component.

For example, adjusting the pH of tobacco changes the natural balance of those acid-base reactions that bind certain classes of chemicals within the tobacco. For example, in natural tobacco leaf, nicotine tends to bind with organic acids that are present in the leaf and hence is more stable and less likely to volatilize when exposed to mild heat. If the pH of the leaf is raised, this reduces the nicotine's natural association with the acids. Such unbound of “free” nicotine is more volatile. The same principle applies to other chemical equilibria within tobacco.

In some embodiments, the pH of the aerosol-generating material is adjusted to at least about 7.5, at least about 8, at least about 8.5, at least about 9, at least about 9.5 or at least about 10. In some embodiments, the pH is adjusted to no higher than about 14, no higher than about 13.5, no higher than about 13, no higher than about 12.5, no higher than about 12, no higher than about 11.5, no higher than about 11, no higher than about 10.5 or no higher than about 10. In some embodiments, the pH of the aerosol-generating material is adjusted to from about 8 to about 10, or from about 8.5 to about 9.5.

In some embodiments, the pH is adjusted to from about 7.5 to about 10, or from about 8 to about 9, or to about 8.5, about 9, about 9.5 or about 10.

In some embodiments, the base used to adjust the pH is a hydroxide or a carbonate. Hydroxides used may be monoacidic bases, diacidic bases or triacidic bases. Suitable bases include, for example, potassium hydroxide, calcium hydroxide, silver hydroxide, ammonium hydroxide, magnesium hydroxide, sodium carbonate, sodium bicarbonate (also known as sodium hydrogen carbonate), and potassium carbonate.

The base may be added to the feedstock material from which the portions of the aerosol-generating components are formed in the form of a liquid, such as an aqueous or non-aqueous solution or suspension, or in the form of a solid, such as a powder.

In some embodiments, the buffer system used to adjust the pH is a mixture of a weak base and its conjugate acid. Suitable buffer systems include, for example, ones having a pH of at least about 7.5, at least about 8, at least about 8.5 or at least about 9. In some embodiments, the pH of the buffer system is from about 8 to about 10, or from about 8.5 to about 9.5. Suitable buffer systems include, for example, those based on ammonia, carbonates or hydroxides, with suitable counterions. An example of a specific buffer system is a mixture of ammonia and ammonium chloride.

In some embodiments, two or more of the portions of the aerosol-generating component have different aerosol release profiles. This means that when the aerosol-generating component is heated, irradiated or energized in any other way, an aerosol is generated with a different release profile. This means that the rate and/or duration of release of the aerosol and/or of one or more components of the aerosol, is different.

Whilst it may be desirable, in some embodiments, for a portion of the aerosol-generating component to include a base or acid to provide an adjusted pH, some constituents of aerosol-generating materials may not be compatible with the adjusted pH. For example, some actives and flavors are pH-sensitive. The distinct portions of the aerosol-generating components described herein make it possible to separate such pH-sensitive constituents from the pH-adjusted aerosol-generating material. Other incompatible constituents of the aerosol-generating material may also be accommodated in such distinct portions of the aerosol-generating component.

Additive Manufacturing Process

Additive manufacturing builds a three-dimensional object from a computer-aided design (CAD) model, usually by successively adding material layer by layer. Various processes may be used to join or solidify material under the control of a computer to create a three-dimensional object.

The term “additive manufacturing” is used herein to refer to a variety of processes, including, for example, printing processes that deposit a material with dispensing heads layer by layer (“3D printing”).

In some embodiments, the additive manufacturing process uses one or more different feedstock materials to produce an aerosol-generating component. For example, a first feedstock material may be used to form a first portion of the component and a second feedstock material may be used to form a second portion of the component.

The additive manufacturing process involves laying down the feedstock layer upon layer. In embodiments where the aerosol-generating component comprises two or more portions, the first layer of the second portion may be laid down on the first portion so that a unitary component comprising multiple portions is produced. These portions are attached to one another and may not be readily separated from one another. This is in contrast, for example, to a component that is made of separate portions that are subsequently attached to one another, for example by a bonding or fusing step.

In some embodiments, the apparatus for performing the additive manufacturing process is an apparatus that may be used to sequentially deposit feedstock material layer upon layer to form a three-dimensional object under the control of a computer program. In particular embodiments, the additive manufacturing process is 3D printing and suitable apparatus for performing this include 3D printers having a dispensing head that lays down multiple layers of feedstock material to form a three-dimensional object. In general, print heads contain chambers that get fed the feedstock to be deposited and nozzles that spray out the feedstock in a highly controlled manner.

In some embodiments, the feedstock material used to prepare the aerosol-generating components is a paste or slurry. In such embodiments, the additive manufacturing process is a paste or slurry extrusion 3D printing process.

In some embodiments, layers of a feedstock material are deposited in a controlled manner to provide an aerosol-generating component comprising an aerosol-generating material. This process may be carried out to produce an aerosol-generating component of the desired shape and size.

In some embodiments, layers of a first feedstock material are deposited in a controlled manner to provide a first portion of the aerosol-generating component comprising a first aerosol-generating material, followed by layers of a second feedstock material being deposited in a controlled manner to provide a second portion of the aerosol-generating component comprising a different aerosol-generating material. This process may optionally be continued with further feedstock materials to produce an aerosol-generating component of the desired shape and size and comprising multiple portions of aerosol-generating materials.

The viscosity of the feedstock and properties of the additive manufacturing apparatus, such as the size of the nozzle aperture and/or the speed at which the feedstock is delivered, can be optimized to allow the features of the aerosol-generating component to be tailored to its proposed use.

In an optional further step, the aerosol-generating component is treated following the additive manufacturing process. For example, the component prepared by the additive manufacturing process may be subsequently cured. Curing may, in some embodiments, involve exposure to a suitable heat source, for example, hot air, infrared, laser or plasma jet.

The additive manufacturing process provides important flexibility with regard to the three dimensional shape of the aerosol-generating component disclosed herein. For example, in some embodiments it is desirable to provide a component with a large surface area and the additive manufacturing process may be used to produce components with channels and/or with intricate cross-sectional shapes (such as Y-, X- or star-shaped) to maximize the surface area whilst still retaining the necessary strength and stability of the components.

Delivery System

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokeable material); and
non-combustible aerosol provision systems that release compounds from an aerosol-generating material without combusting the aerosol-generating material, such as tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising an aerosol-generating component as disclosed herein and configured to be used with non-combustible aerosol provision devices.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In some embodiments, the aerosol generator is configured to acts on the aerosol-generating component to generate an aerosol from multiple portions of the aerosol-generating component at the same time. In some embodiments, the aerosol generator acts on all of the portions of the aerosol-generating component at the same time. In other embodiments, the aerosol generator is configured to act on different portions of the aerosol-generating portion sequentially. In such embodiments, the aerosol generated will change during use of the delivery system.

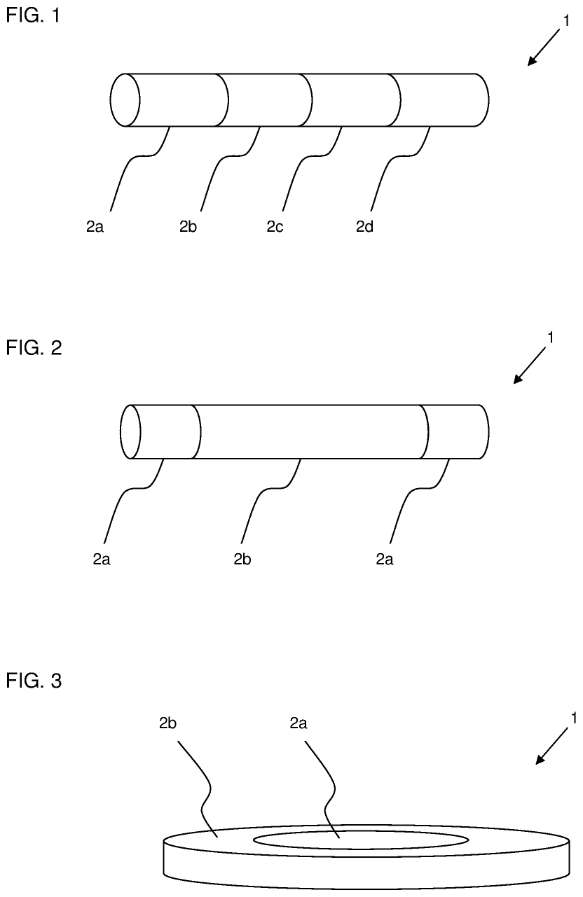

FIG. 1 is a schematic illustration of an aerosol-generating component according to an embodiment described herein. The aerosol-generating component 1 comprises a series of aligned portions 2a, 2b, 2c, 2d, each comprising a different aerosol generating material, optionally wherein the aerosol-generating materials comprising different actives and/or flavors.

FIG. 2 is a schematic illustration of another aerosol-generating component according to an embodiment described herein. The aerosol-generating component 1 comprises a series of aligned portions. The first portions 2a comprise a first aerosol-generating material and the central, second portion 2b comprises a second, different aerosol-generating material.

FIG. 3 is a schematic illustration of a yet further aerosol-generating component according to an embodiment described herein. The aerosol-generating component 1 comprises a disc-shaped first portion 2a comprising a first aerosol-generating material, surrounded by a second portion 2b comprising a second, different aerosol-generating material.

Other shapes and configurations of two or more portions of the aerosol-generating component are contemplated. The size and shape of the aerosol-generating component will, in some embodiments, be dictated by the delivery system used to generate the aerosol.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A process for preparing an aerosol-generating component comprising at least one active that is not nicotine, wherein the at least one active is included in a feedstock material that is used to form the aerosol-generating component by an additive manufacturing process.

2. A process as claimed in claim 1, wherein the active that is not nicotine is selected from the group consisting of 5-Hydroxytryptophan (5-HTP)/oxitriptan/Griffonia simplicifolia, Acetylcholine, Arachidonic acid (AA, Omega-6), Ashwagandha (Withania somnifera), Bacopa monniera, Beta Alanine, Beta-Hydroxy-Beta-Methylbutyrate (HMB), Caffeine, Chai-hu, Chamomile, Cherry blossom Cinnamon, Citicoline, Cotinine, Creatine, Curcumin, Docosahexaenoic acid (DHA, Omega-3), Dopamine, Dorstenia arifolia, Dorstenia odorata, Essential oils, Fennel, GABA, Galphimia glauca, Ginger, Ginkgo, biloba, Ginseng, Glutamic acid, Guarana, Hops, Jasmine, Kaempferia parviflora (Thai ginseng), Kava, L-carnitine, L-arginine, Lavender Oil, L-choline, Lemon balm, Lemongrass, Liquorice, L-lysine, L-theanine, L-tryptophan, Lutein, Magnesium, Magnesium L-threonate, Matcha, Melatonin, Myo-inositol, Nardostachys chinensis, Nitrate, Oil-based extract of Viola odorata, Oxygen, Phenylalanine, Phosphatidylserine, Quercetin, Resvaratrol, Rhizoma gastrodiae, Rhodiola, Rhodiola rosea, Rose essential oil Rosemary, S-adenosylmethionine (SAMe), Sceletium tortuosum, Schisandra, Selenium, Serotonin, Skullcap, Spearmint extract, Spikenard, Taurine, Terpens, Theacrine, Theobromine, Tumaric, Turmeric, Turnera aphrodisiaca, Tyrosine, Valerian, Vitamin A, Vitamine B12 (Colabamin), Vitamin B3, Vitamin B6, Vitamin C and Yerba mate.

3. A process as claimed claim 1, wherein the aerosol-generating component comprises at least one further active.

4. A process as claimed in claim 3, wherein the at least one further active is included in at least one further feedstock material used to form the aerosol-generating component.

5. A process as claimed in claim 1, wherein the aerosol-generating component further comprises nicotine.

6. A process as claimed in claim 5, wherein the feedstock material comprises tobacco material.

7. A process as claimed in claim 1, wherein the aerosol-generating component is a unitary aerosol-generating component comprising at least two portions comprising different actives.

8. A process as claimed in claim 7, wherein the at least two portions are formed by the additive manufacturing process using different feedstock materials.

9. A process as claimed in claim 1, wherein the additive manufacturing process forms a three-dimensional object from the feedstock materials using a computer-aided design (CAD) model.

10. A process as claimed in claim 1, wherein the additive manufacturing process is a 3D printing process depositing layer upon layer of feedstock material.

11. An aerosol-generating component comprising at least one active that is not nicotine, wherein the aerosol-generating component is formed by an additive manufacturing process from a feedstock material comprising the at least one active.

12. An aerosol-generating component as claimed in claim 11, wherein the aerosol-generating component comprises at least one further active.

13. An aerosol-generating component as claimed in claim 12, wherein the at least one further active is included in at least one further feedstock material used to form the aerosol-generating component.

14. An aerosol-generating component as claimed in claim 11, wherein the active that is not nicotine is selected from the group consisting of 5-Hydroxytryptophan (5-HTP)/oxitriptan/Griffonia simplicifolia, Acetylcholine, Arachidonic acid (AA, Omega-6), Ashwagandha (Withania somnifera), Bacopa monniera, Beta Alanine, Beta-Hydroxy-Beta-Methylbutyrate (HMB), Caffeine, Chai-hu, Chamomile, Cherry blossom Cinnamon, Citicoline, Cotinine, Creatine, Curcumin, Docosahexaenoic acid (DHA, Omega-3), Dopamine, Dorstenia arifolia, Dorstenia odorata, Essential oils, Fennel, GABA, Galphimia glauca, Ginger, Ginkgo, biloba, Ginseng, Glutamic acid, Guarana, Hops, Jasmine, Kaempferia parviflora (Thai ginseng), Kava, L-carnitine, L-arginine, Lavender Oil, L-choline, Lemon balm, Lemongrass, Liquorice, L-lysine, L-theanine, L-tryptophan, Lutein, Magnesium, Magnesium L-threonate, Matcha, Melatonin, Myo-inositol, Nardostachys chinensis, Nitrate, Oil-based extract of Viola odorata, Oxygen, Phenylalanine, Phosphatidylserine, Quercetin, Resvaratrol, Rhizoma gastrodiae, Rhodiola, Rhodiola rosea, Rose essential oil Rosemary, S-adenosylmethionine (SAMe), Sceletium tortuosum, Schisandra, Selenium, Serotonin, Skullcap, Spearmint extract, Spikenard, Taurine, Terpens, Theacrine, Theobromine, Tumaric, Turmeric, Turnera aphrodisiaca, Tyrosine, Valerian, Vitamin A, Vitamine B12 (Colabamin), Vitamin B3, Vitamin B6, Vitamin C and Yerba mate.

15. An aerosol-generating component as claimed in claim 11, wherein the aerosol-generating component further comprises nicotine.

16. An aerosol-generating component as claimed in claim 15, wherein the aerosol-generating component comprises tobacco material.

17. An aerosol-generating component as claimed in claim 11, wherein the aerosol-generating component is a unitary aerosol-generating component comprising at least two portions comprising different actives.

18. An aerosol-generating component as claimed in claim 17, wherein the at least two portions comprise different aerosol-generating materials.

19. An aerosol-generating component as claimed in claim 17, wherein a first portion comprises the at least one active that is not nicotine and a second portion comprises a second active that is different to the first active.

20. An aerosol-generating component as claimed in claim 17, wherein the first and second portions have a different pH.

21. A delivery system comprising an aerosol-generating component as claimed in claim 11.

22. A delivery system as claimed in claim 21, wherein the delivery system is a non-combustible aerosol provision system.

23. A delivery system as claimed in claim 22, comprising a heating means to heat the aerosol-generating component.

24. A consumable comprising an aerosol-generating component as claimed in claim 11.
